(19) United States
(12) Patent Application Publication
(10) Pub. No.: US 2025/0024993 A1
(43) Pub. Date: Jan. 23, 2025

(54) BATTERY ASSISTED ELECTRIC GRILL

(71) Applicant: Channel Products, Inc., Solon, OH (US)

(72) Inventors: David Hartwell, Medina, OH (US); David J. Kolar, Stow, OH (US); James S. Becker, Lyndhurst, OH (US)

(73) Assignee: Channel Products, Inc., Solon, OH (US)

(21) Appl. No.: 18/776,654

(22) Filed: Jul. 18, 2024

Related U.S. Application Data
(60) Provisional application No. 63/514,232, filed on Jul. 18, 2023.

(51) Int. Cl. A47J 37/07; H02S 20/30

(52) U.S. Cl. CPC A47J 37/0709; H02S 20/30

(57) ABSTRACT

An electric barbecue grill has a heating element configured to generate heat to cook food. A grate may have a cooking surface. The heating unit can be received within or integrated into the grate. A power distribution unit can be configured to receive power from an external power source and/or an energy storage device. The power distribution unit can distribute power to the heating element. The energy storage device can be rechargeable. The electric grill can include a controller and sensors to detect and adjust operating conditions of the grill to provide intelligent cooking capability. A sensor may detect food on a grill grate and a level of doneness of the food. A housing of the grill can include a powered vent that can close if a flame is detected within the housing. The electric grill can include solar panels to provide additional power to the power distribution unit.

### CROSS-REFERENCE TO RELATED APPLICATION(S)

This application claims priority to U.S. Provisional application No. 63/514,232, entitled “BATTERY ASSISTED ELECTRIC GRILL,” filed on Jul. 18, 2023. The entirety of the above-mentioned application is incorporated herein by reference.

### BACKGROUND

Charcoal and gas grills have been a back yard staple in America for many years. There has been an evolution from charcoal, to gas grills, and now to electric grills. Users may perceive electric grills to be inadequate because electric grills tend to be small and underpowered. Charcoal grills and gas grills, like propane and natural gas grills, emit greenhouse gases that may harm the environment. Many gas grills rely on fuel tanks that need to be periodically replaced or refilled. Users therefore have to travel to have their fuel tanks refilled and may be uncomfortable traveling with a full fuel tank in the back of their passenger vehicle.

Users of electrical grills may consider electrical grills small and underpowered because of a number of issues and limitations common to conventional electrical grills. For example, current electrical grills may be limited by power output. For instance, most plug-in portable appliances in the United States are capped between 1500-1800 W. This is due to standards and regulations but also physical limitations and the power available from a wall socket. Further, current battery technology may not have the energy density to not allow for sufficient and consistent heat to be generated by the grill for an extended period of time. Because of this, electrical grills may not be perceived as a sufficient grilling tool when compared to gas and charcoal grills.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In one implementation, the electric grill uses an energy storage device battery. The battery may increase the performance of the grill. For instance, the battery may significantly increase the wattage and power output of the grill. It may increase the heat output of the electric gill and allow the user to achieve sufficient grilling and having a cooking area large enough to cook for a party or larger gathering. The grill may provide enough heat to achieve the Maillard Effect, which provides grill or sear marks commonly obtained from high heat cooking on a grill.

In another implementation, the battery assisted grill may include powered grate cooking, in which the grate members themselves contain embedded heating elements. Additionally, the battery assisted grill may include additional smart features like a touch to open lid, externally operated fans, and a means for detecting the weight of the food on the electric grill to determine grilling power and cooking readiness.

In another implementation, an electric barbecue grill may comprise a heating element configured to generate heat to cook food. The electric grill may comprise a power distribution unit configured to receive power from an external power source and/or an energy storage device. The power distribution unit may be configured to distribute power to the heating element.

In another implementation, an electric barbecue grill may comprising a heating element configured to generate heat to cook food. The electric grill may comprise a solar panel configured to receive light from the sun and convert it to power. The electric grill may further comprise a power distribution unit configured to receive power from an external power source, the solar panel and/or an energy storage device. The power distribution unit may be configured to distribute power to the heating element.

In another implementation, an electric barbecue grill may comprise at least one heating element configured to generate heat to cook food. The electric grill may comprise at least one grate configured to receive heat from the heating element. The grate may have a cooking surface. The grill may further comprise a power distribution unit configured to receive power from an external power source and/or an energy storage device. The power distribution unit may be configured to distribute power to the at least one heating element. The electric grill may further comprise a controller that receives input data from a user interface and outputs control signals to control the power distribution unit. The controller may include at least one processor and a memory that stores instructions. When executed by the at least one processor, the instructions may configure the at least one processor to distribute power to the heating element from the external power source or the energy storage device based on the input data to adjust a cooking temperature of the electric grill.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIG. 1 is a schematic drawing of one implementation of the a battery assisted electric grill.

FIG. 2 is a front perspective view of what is disclosed herein.

FIG. 3 is another front perspective view of a battery assisted electric grill, which is disclosed herein.

FIG. 4 is a rear perspective view of a battery assisted electric grill disclosed herein.

FIG. 5A is a component diagram illustrating the charge mode of the battery assisted electric grill.

FIG. 5B is a component diagram illustrating the run mode of the battery assisted electric grill.

FIG. 6 is a perspective view of an exemplary grate that includes the channels configured to receive the heating element.

FIG. 7A is a perspective view of an exemplary heating element.

FIG. 7B is a perspective view of an exemplary heating element having a heating zone and a searing zone.

FIG. 8 is a perspective view of an exemplary electric grill having an inductive heating element and an inductive grate.

FIG. 9 is a block diagram illustrating a control strategy for the adjustment of the temperature within the compartment of an electric grill having a lid sensor.

FIG. 10 is a view of an exemplary electric grill having solar panels and a solar panel tracking system.

FIG. 11 is a perspective of an exemplary housing and lid assembly illustrating the lid in the closed position.

FIG. 12 is a block diagram illustrating an exemplary control system.

### DETAILED DESCRIPTION

A battery assisted electrical grill may solve the issues and limitations present in current electrical grills. The use of one or more batteries can provide an electrical grill with additional wattage and power. Battery technology in the last decade has made multiple technological and safety improvements. Further, the energy density in batteries continues to increase making battery powered concepts feasible that were not previously feasible. As such, the battery assisted grill may provide additional heating power for an extended period of time. The battery assisted electric grill may provide additional benefits. For instance, battery grills are better for the environment and do not emit greenhouse gases in the same way charcoal and propane grills do. Battery assisted electrical grills could be used inside the home. Further, the battery assisted electric grill eliminates the need to travel to purchase and/or refill fuel tanks and the uncomfortable feeling of driving with a fuel tank in a passenger vehicle.

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

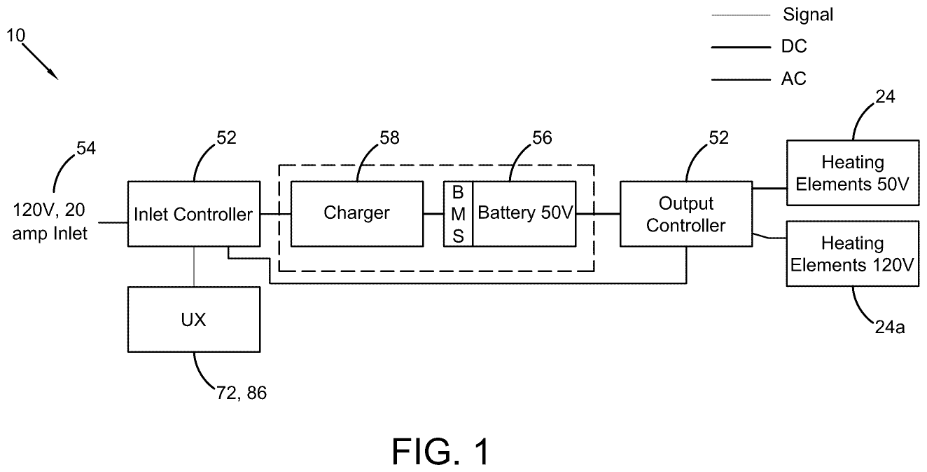

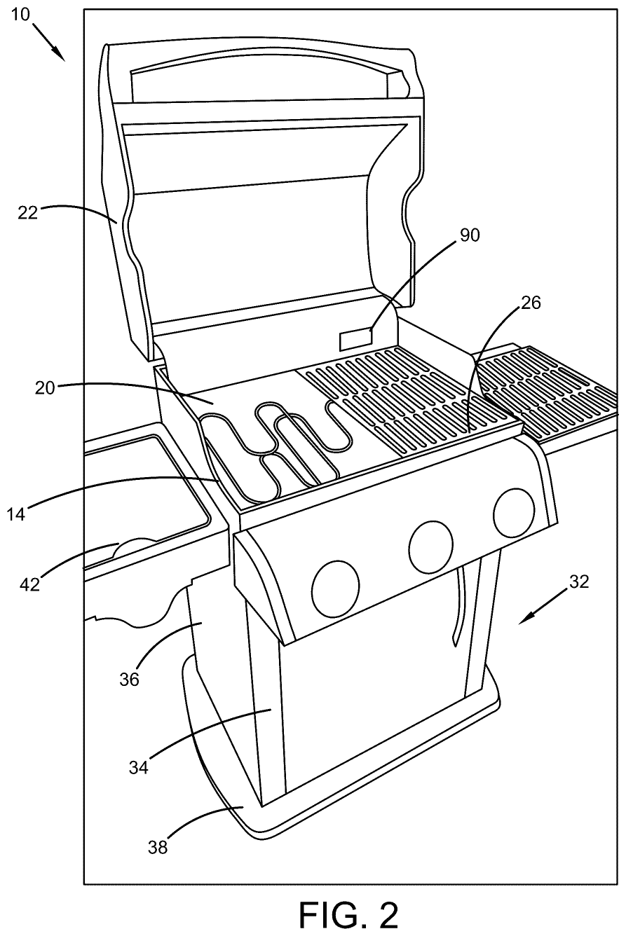

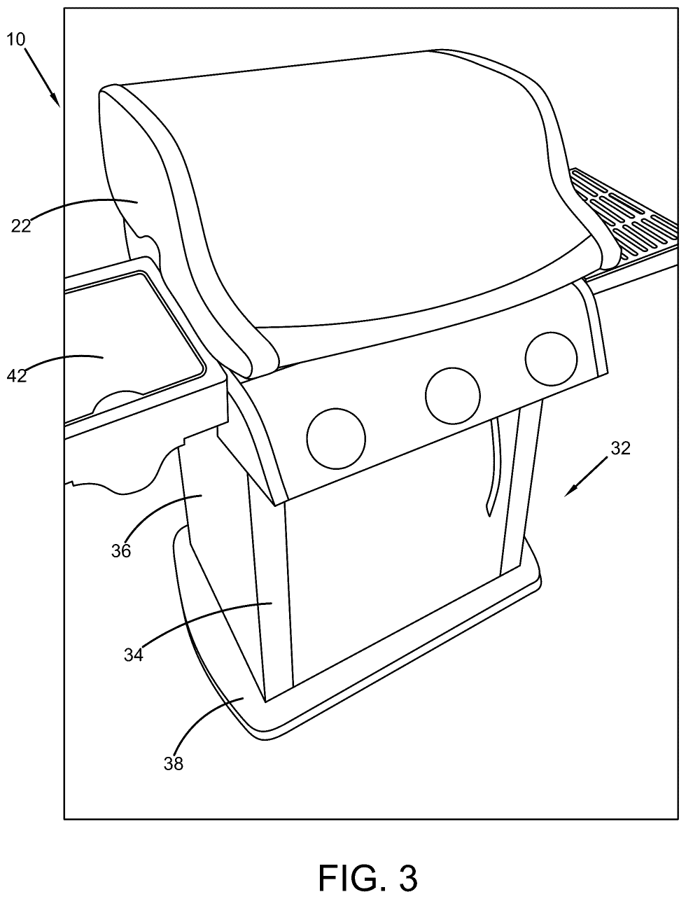

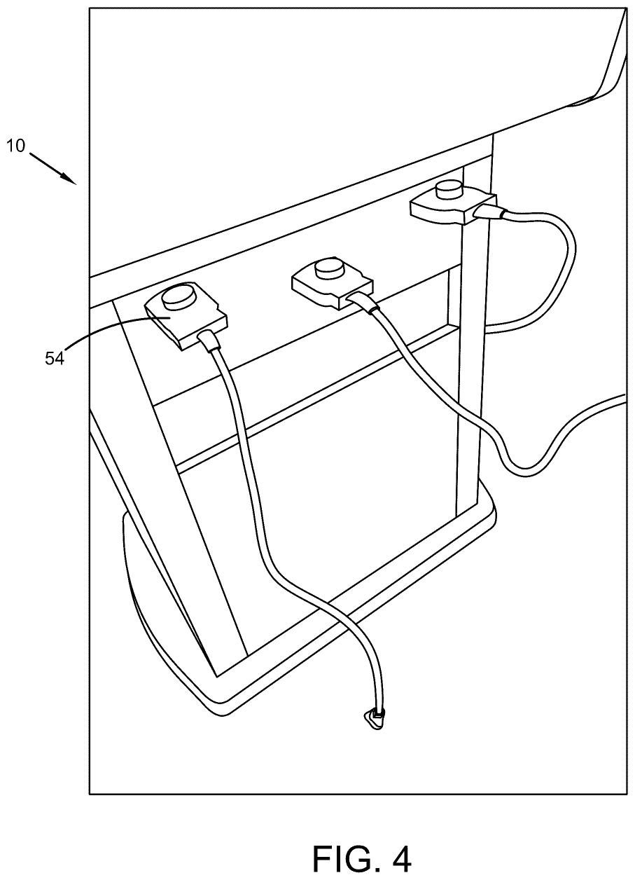

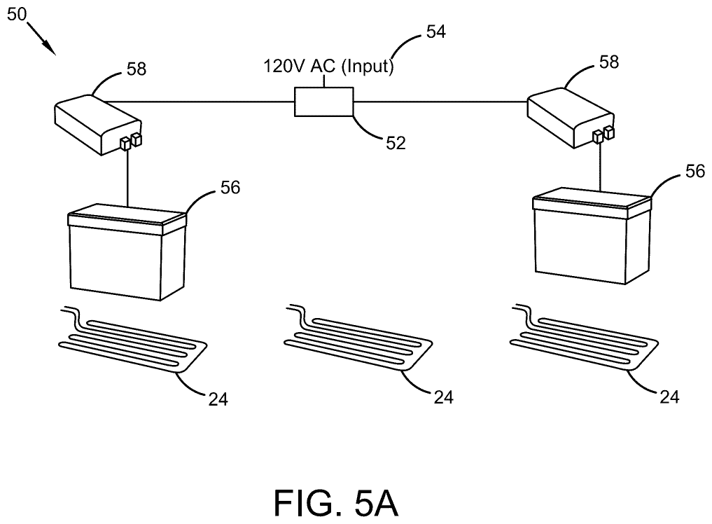

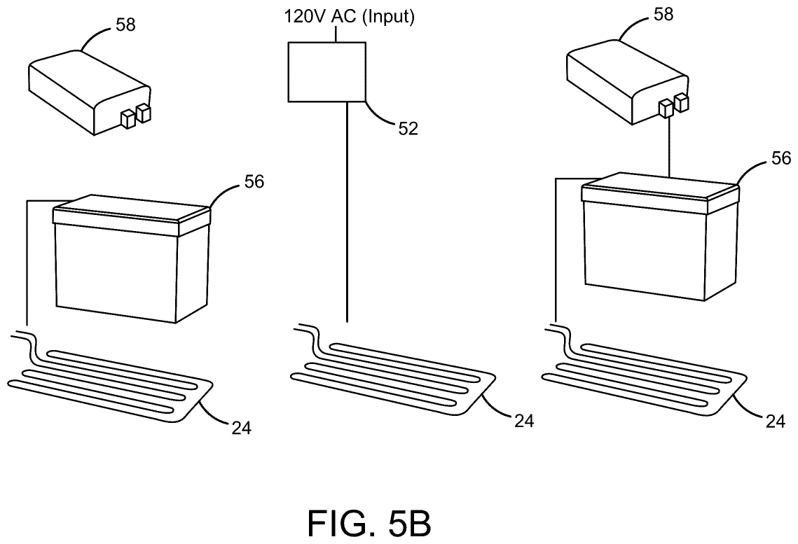

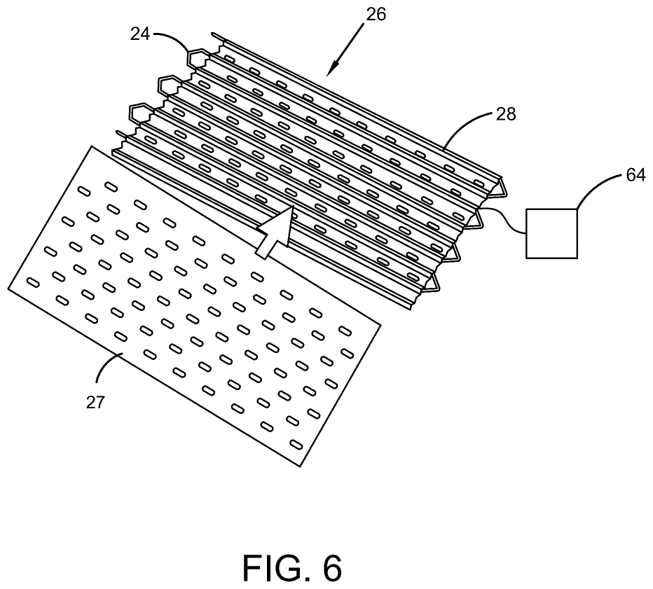

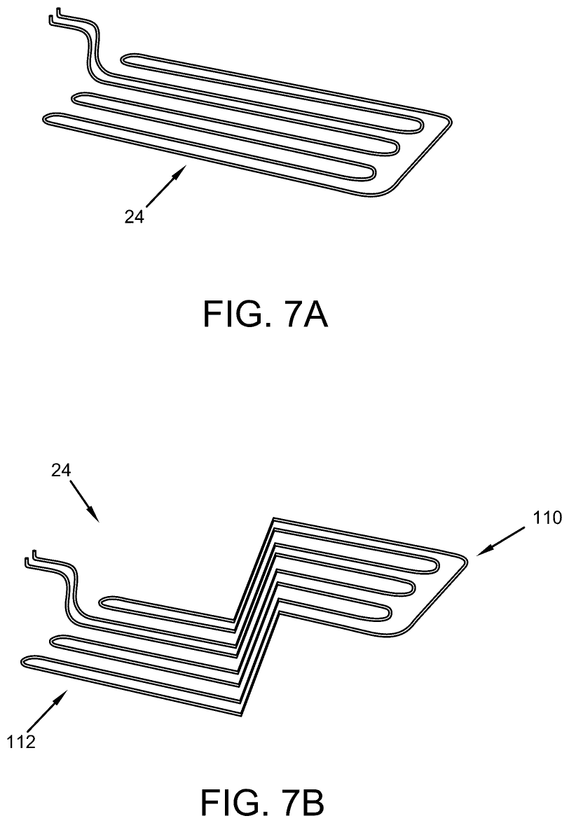

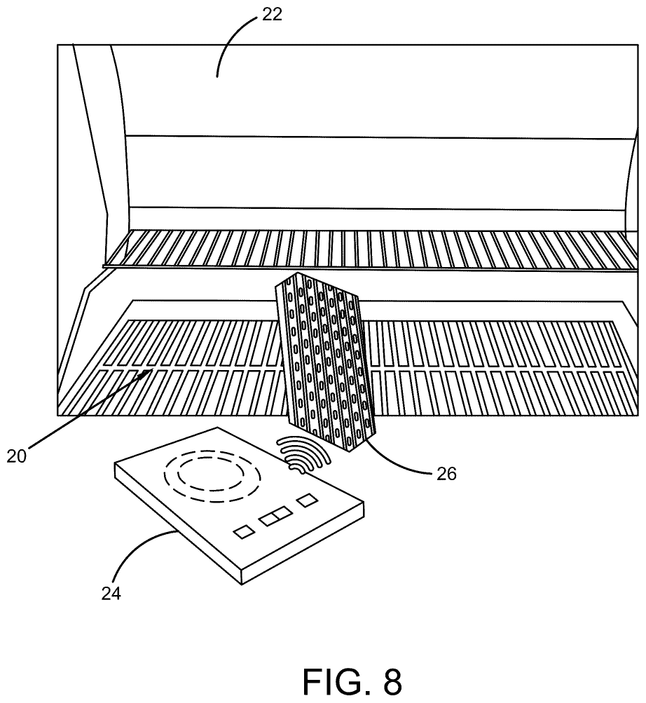

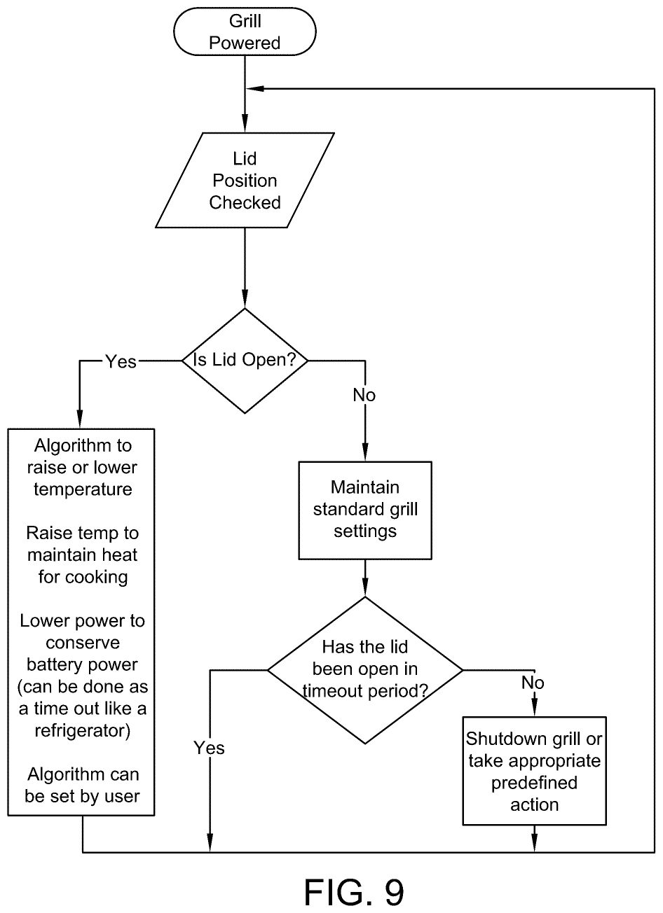

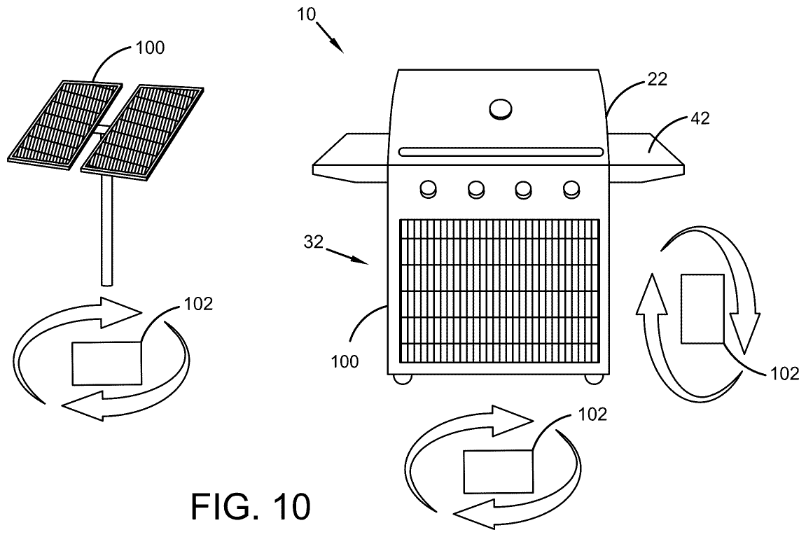

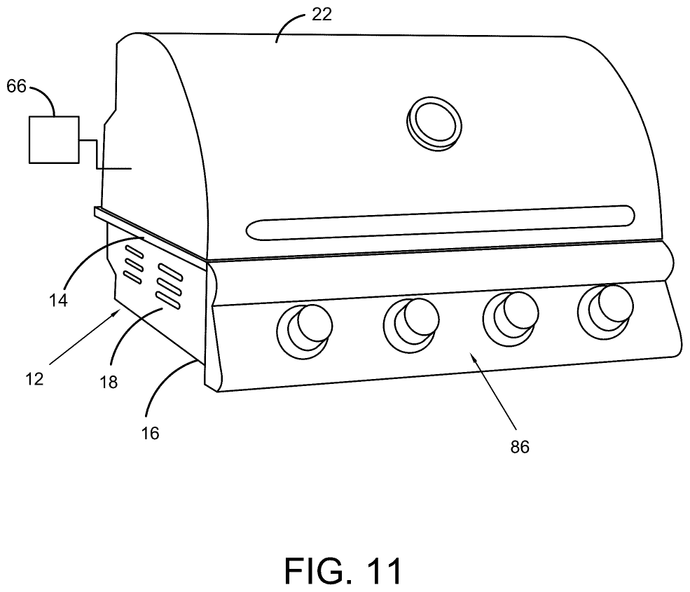

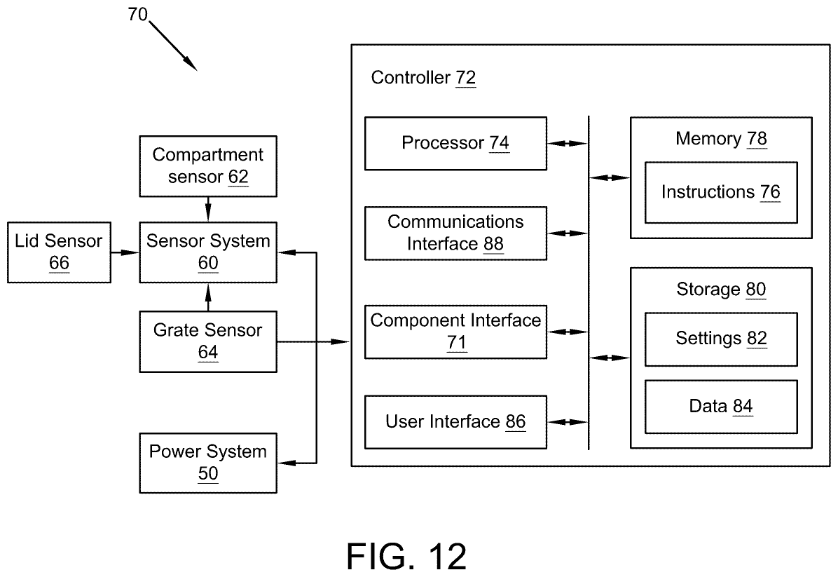

Turning to FIG. 1, an electric grill 10 has a housing 12 having an open end 14 and a bottom 16 opposite the open end 14. The housing 12 has sidewalls 18 that extend between the open end 14 and the bottom 16. The open end 14, the bottom 16, and the sidewalls 18 define a compartment 20 configured to receive components of the electric grill 10. The electric grill 10 may have a lid 22 configured to selectively engage and cover the open end 14. The lid 22 may be separate from the housing 12 and the user can selectively remove the lid 22 from the housing 12 to access the compartment 20. Alternatively, the lid 22 may be movably coupled to the housing 12. For instance, the lid 22 may be pivotally coupled to the housing 12 such that it has an open position where the user has access to the compartment 20 and a closed position where the user lid engages the open end 14 and prevents access to the compartment 20.

The electrical grill 10 may have a heating element 24 within the compartment 20. As will be discussed in further detail below, the heating element 24 may be configured to receive power from a power source to generate heat within the compartment 20 to cook food within the compartment. The heating element 24 may be selectively positionable within the compartment 20. It will be appreciated that more than one heating element 24 may be used with the electric grill to generate heat within the compartment 20. The electric grill 10 may include multiple heating elements 24 different heating zones within the compartment 20. For example, the electric grill 10 may have two, three, four, or some other suitable number of heating elements 24 to heat the compartment 20. Generally, the heating element 24 may be a coiled structure made of resistive material that heats up as electric current passes through the heating element 24.

The electric grill 10 may have a grate 26 removably positioned within the compartment 20. The grate 26 may be positioned in the compartment 20 such that the grate contacts the heating element 24 or is some distance above the heating element 24. The grate 26 may provide a cooking surface 28 that the user can place food on to cook the food. As such, the grate 26 may be configured to receive heat from the heating element 24 and transfer the heat to the cooking surface 28 to cook food on the cooking surface 28. The cooking surface 28 may be made of a plurality of ridges with a plurality of spaces in between the ridges to provide grill marks common to grilled food. Alternatively, the grate 26 may have a cooking surface 28 made up of a cross-hatched pattern of ridges. In another alternative implementation, the cooking surface 28 be a solid continuous metal surface. It will be appreciated that multiple grates 26 may be included in the compartment 20. For instance, two, three, four, or some other suitable number of grates 26 may be included in the compartment. Grate supports 30 may extend into the compartment 20 from the sidewalls 18 near the open end 14 to support the grates 26 within the compartment 20. For instance, a plurality of grate supports 30 in the form of tabs may extend into the compartment 20 equally spaced around the perimeter of the open end 14. Alternatively, a grate support 30 may extend inwardly from each sidewall 18 along the entire length of each sidewall 18 such that the grate support 30 extends around the entire perimeter of the housing 12 near the open end 14.

The electric grill 10 may include a stand 32 configured to engage the bottom 16 of the housing 12 to support the housing 12. The stand 32 may include a plurality of legs 34, each leg having a top 36 configured to engage the bottom 16 of the housing 12 and a bottom 38 opposite the top 36 configured to engage a substrate, like the ground, a patio, or deck, which supports the electric grill 10. At the tops 36 of the plurality of legs 34, the bottom 16 of the housing 12 may be secured to the stand 32. For instance, a plurality of mechanical fasteners like bolts, screws, or pins may secure the housing 12 to the stand 32. Alternatively, the housing 12 may simply rest on the stand 32. To assist with moving and positioning the electrical grill 10, the bottom 38 of each of the plurality of legs 34 may include a caster and/or wheel. A shelf 40 may extends between the plurality of legs below the housing to provide storage for components of the grill or grill related accessories. It will be appreciated that multiple shelves may be included below the housing. The stand 32 may be an open frame design where the shelf 40 and the bottom 16 of the housing 12 are exposed to the ambient environment. Alternatively, the stand 32 may have sidewalls and doors defining a cabinet below the housing 12 that encloses and protects the stand 32 and shelf 40 from the ambient environment. The electric grill 10 may have a side table 42 that extends out from the sidewall 18 of the housing 12 to provide a working surface at approximately the same height at the cooking surface 28. It will be appreciates that the electric grill 10 may also have a second side table extending out of an opposite side of the housing.

The electric grill 10 may have a power system 50 configured to receive power from a power source and provide power to the heating elements 24 within the compartment 20. The power system 50 has a power distribution unit 52 configured to receive power from a power supply 54 that is operatively engaged with the power source. For instance, the power source may be a single 120V, 20 A socket in the electrical outlet in the wall of a house or building. The power system 50 may further include an energy storage device 56. The energy storage device 56 may be a rechargeable battery, like a lithium-ion battery or some other suitable battery, a supercapacitor, or some other suitable rechargeable energy storage device. As such, the power system 50 may further include a charger 58 that is operatively coupled to the power distribution unit 52. The charger 58 may also be operatively coupled to the energy storage device 56 such that power can flow from the power distribution unit 52 through the charger 58 to the energy storage device 56 to recharge the energy storage device 56. The energy storage device 56 may be operatively connected to the heating element 24 to provide power to the heating element 24 so that the heating element 24 can generate heat. It will be appreciated that the electric grill 10 may include multiple energy storage devices 56. For instance, the electric grill 10 may include one, two, three, four, or any other suitable number of energy storage devices 56. In one implementation, the electric grill 10 may include the same number of energy storage devices 56 as heating elements 24. In another implementation, the electrical grill may include more energy storage devices 56 than heating elements 24 where the additional energy storage devices 56 are configured to provide power to other electrical devices or systems of the electric grill 10. As will be further described below, the power distribution unit 52 can selectively provide power to the heating elements 24, chargers 58, and other electrical devices/systems on the electric grill 10 based on the operation mode of the electric grill 10.

The electric grill 10 may additionally include a sensor system 60. The sensor system 60 may include one or more sensors that, for example, detect conditions related to electrical grill and its operation. For instance, the sensors may be positioned to detect operating conditions of the grill like temperature and the positioning of the electric grill components. The sensors of the sensor system may be of any suitable type. For example, sensors may include a potentiometer, a Hall Effect sensor, a proximity sensor, a microelectromechanical sensor (MEMS), a laser, an encoder, an infrared sensor, a camera, or other type. The sensors of the sensor system may be integrated sensors, which are combined or “integrated” with signal processing hardware in a compact device. The sensors of the system may also be operably connected to any actuators that are included on the electrical grill 10. In some implementations, the sensors may detect a position or speed of an implement by detecting an electrical, magnetic, or other visual condition that is related to the position of the implement. The sensor system 60 may include a compartment sensor 62 configured to detect conditions within the compartment 20. The sensor system 60 may include a grate sensor 64 that may be operatively coupled to the grate 26 and is configured to detect operating conditions of the grate 26. The sensor system 60 may include a lid sensor 66 that may be operatively connected to the lid 22 to and is configured to detect conditions of the lid 22 like the position of the lid.

The electric grill may additionally include a control system 70. The control system 70 may include a controller 72 configured to monitor and control the electric grill 10 and its subsystems, like the power system 50 and the sensor system 60. In one implementation, the controller 72 may be a simple control circuit. In other embodiments, the controller 72 may be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. The controller 72 may be a microprocessor, but in the alternative, the controller 72 may be any processor, controller, microcontroller, or state machine. The controller 72 may also be implemented as a combination of computing devices, for example a combination of a DSP and a microprocessor, a plurality of microprocessors, multi-core processors, one or more microprocessors in conjunction with a DSP core, or any other such configuration.

In another implementation, the controller 72 may be a computing device. The controller 72 may include a component interface 71 configured to communicate with various elements of the grill 10 like the power system 50 and the sensor system 60 to obtain user and sensor input and to convey controller output. The controller 72 may include a processor 74 configured to execute computer-executable instructions 76 such as instructions composing a control system to monitor and adjust conditioning performance as described herein. Such computer-executable instructions 76 can be stored on one or more computer-readable media including non-transitory, computer-readable storage media such as memory 78. Memory 78 can also include other data (working data, sensor data, adjustment data, input data, or variables) or portions thereof during execution of instructions 76 by processor 74. The controller 72 can also include storage 80 that can be, according to an embodiment, non-volatile storage to persistently store instructions 76, settings 82 (e.g., configuration settings) and/or data 84 (e.g., operational data, sensor data, adjustment data, input data, machine inputs, etc.). As will be described in further detail below, the control system 70 may include actuators to assist or automatically move the electric grill 10 or components of the electric grill.

The control system 70 may also include a user interface 86 operatively connected to the controller 72 that comprises various elements to obtain user input and to convey user output. For instance, user interface 86 can comprise of a touch display, which operates as both an input device and an output device. In addition, user interface 86 can also include various buttons, switches, keys, dials etc. by which a user can input information to the controller 72 and other displays, LED indicators, etc. by which other information can be output to the user. Further still, user interface 86 can include input devices such as keyboards, pointing devices, and standalone displays.

The controller 72 may further include a communications interface 88 to couple controller 72, via a communications network, to various devices such as, but not limited to, other computing devices, sensors, other controllers, servers, or Internet-enabled devices (e.g., consumer electronics like mobile devices or tablets). Communication interface 88 can be a wired or wireless interface including, but not limited, a Wi-Fi interface, an Ethernet interface, a Bluetooth interface, a fiber optic interface, a cellular radio interface, a satellite interface, etc.

In one implementation, the electric grill 10 may have a charge mode and a run mode. When the electric grill 10 is not in use, the controller 72 may put the electric grill in charge mode. In charge mode, the power supply 54 may connect to an external power source. The power source may have a voltage in the range of 110V to 240V and a current in the range of 20 A to 30 A. In one implementation, the power source may be a single 120V, 20 A socket in the electrical outlet in the wall of a home or building. The controller 72 may command the power distribution unit 52 to allow power to flow from to the charger 58 to charge the plurality or bank of energy storage devices 56. The energy storage devices 56 may be batteries having a voltage in the range of 24V to 240V and an energy capacity in the range of 20 Ah to 200 Ah. In one implementation, the energy storage devices may be 48V, 50 Ah batteries. Charging may take no more than three hours in some implementations, and in other examples, charging may be no more than 2.75 hours. When the energy storage devices 56 have been fully charged, the controller 72 may terminate the charge mode and command the power distribution unit to draw power longer from the outlet. When the user would like to use the electric grill 10, the controller 72 may put the electric grill 10 in run mode based on user input into the user interface 86. In run mode, the controller 72 can command the power distribution unit 52 to meter the battery voltage from the energy storage devices 56 to one or more heating element 24. Further, because the power distribution unit 52 is no longer charging the energy storage devices 56, the power distribution unit 52 can provide power from the power supply 54 to the an AC heating element 24a configured to receive power from the wall outlet at 120V at 20 amps. In this configuration, the total power can reach 4800 W, which is more than triple the current state of the art electric grills.

When the electric grill 10 is in run mode, the electrical outlet in the wall may provide 1500 W-1800 W of power to power the electric grill 10, and the energy storage devices 56 may also power resistive heating elements 24 in the compartment 20 for a total combined output power of 4500 W-5000 W. Many common gas grills on the market are rated to 20,000 BTU/hr to 30,000 BTU/hr. Gas grills are inefficient due to the combustion and cool flu air required for the combustion process. Much of this energy is wasted and can even present a hazard to nearby walls and outdoor siding (melt and fire) when that heat is exhausted from the back of the grill. The electric grill 10 may effectively output approximately 15,000 BTU/hr (4.5 kW) of power. The electric grill 10 may be more efficient because it does not need to be vented like a gas grill. Therefore, the electric grill 10 has the ability to grill and heat with less energy.

In another implementation, the electric grill 10 may include a convection fan 90 in the compartment 20 to produce convective cooking. The fan 90 may cause the air to circulate in the compartment 20, which may cause the food to cook faster. The fan 90 may have a motor 92 and a sensor 94 located outside of the high temperature environment in the compartment 20. The fan 90 may also have a fan blade 96 disposed within the compartment 20 or in fluid communication with the compartment 20 to circulate the air in the chamber. The fan blade 96 may be coupled to an output shaft 98 of the motor 92 that extends through the walls of the housing 12. While the fan 90 is operated, the motor 92 may rotate the output shaft 98 and therefore the fan blade 96 to circulate the air in the in the compartment 20.

In another implementation, the electric grill 10 may also have a heating element 24 integrated into the grate 26. For instance, the electric grill 10 may have a heating element 24 embedded directly into the grate 26 such that the grate 26 itself is power by the energy storage device 56 and therefore heated. Alternatively, the grate 26 may have channels configured to accept the coiled structure of the heating element 24 and the heating element 24 may be retained in the channels by a backing plate 27. The grate 26 could have open air passages and look similar or identical to a standard grill grate.

In another implementation, the heating element 24 may be an inductive power unit disposed within the compartment 20. In this configuration, the grate 26 may be made of a material that heats up when exposed to an electromagnetic field generated by the inductive heating element 24. For instance, the grate 26 could be made of iron, steel, stainless steel, copper, or some other metal or metal alloy suitable for inductive heating. The grate 26 may have a receiver coil on it to receive the power or the shape of the grate itself could be built in such a way that the radiated power can induce into the grill grate surface directly.

The electric 10 grill may have a variety of smart features and control strategies. These features and strategies may be stored in the memory 78 and/or storage 80 of the controller 72. The controller may control the electric grill 10 based on user input or sensor data from the sensor system 60. For instance, the controller 72 could include pre-defined multistage cooking programs featuring different heating cycles, like a heating cycle and a searing cycle, which could be selectively or intelligently controlled. For instance, the controller 72 can control the power distribution unit 52 to control the power provided to the heating element 24 based on input from physical controls on the electric grill 10 or from a mobile device in communication with the grill. The heating elements 24 could be embedded in a two-part or single piece cast iron grate, and therefore the grill grate could be directly powered. A user may select a multistage cooking program featuring different heating cycles. For instance, a program may have a cooking stage and a searing stage. During the searing stage, which could occur before or after the cooking stage, the controller 72 may cause the heating elements 24 to produce high heat to add sear marks on the food.

In another implementation, the lid 22 may include smart features. For instance, the sensor system 60 may include a limit switch, tilt sensor and/or similar sensor operatively coupled to the lid 22. The switch or sensor could detect the motion and position of the lid 22. If the lid 22 is not lifted on a regular basis or if the lid has not be lifted for a specified time period, the controller 72 could be configured to shut down the electric grill 10, alert the user, and/or go to a low power mode where the power distribution unit 52 provides less power to the heating elements 24 and the heating elements 24 generate less heats as result. Further, the data from the lid sensor could be provided to the controller to determine when the lid is in the open state or the closed state, and the controller 72 could command the power distribution unit 52 to increase or decrease the power provided to the heating elements based on the position of the lid 22. For instance, if the lid 22 is in the open position, the controller 72 could command the power distribution unit 52 to provide more power to the heating element 24 to increase the heat generated by the heating element 24 as more heat could be lost to the ambient environment when the lid 22 is open. Conversely, if the lid is closed, the controller 72 could command the power distribution unit to decrease the power provided to the heating element 24. This feature could be customized and programmed by the user/owner. For instance, the user could increase or decrease the power output based on movement of the lid to create the optimal cooking environment.

The sensor system 60 may have a microphone, thermometer, infrared sensor, smoke sensor or other sensors. These sensors could be placed within the grilling compartment or directly outside to detect the temperature within the compartment 20, cooking, and noises like sizzling that occur when the electric grill is on and cooking food. The sensor data can be interpreted by the processor 74, and the controller 72 can adjust the heating/time durations and cooking parameters to aid in intelligent cooking. The sensor data can be sent to a cloud based system for further analysis, including without limitation, analysis by an artificial intelligence system or a database. As an example, the sensors could also detect if the food is burning and the controller 72 could adjust the temperature within the compartment 20 or even shut the electric grill 10 off. The sensor system 60 could further include sensors and electronics that can only operate in low temperatures, such as cameras or other sensors. These sensors could take readings to produce sensor data that can be interpreted by the processor 74 and the sensors could be moved out of the high temperature compartment either manually or automatically.

In another implementation, the heating elements 24 and/or the grate 26 may include sensors configured to detect flames to provide flame feedback to the controller 72. Accordingly, depending on the position of the heating elements 24, the heating elements 24 or the grates 26 could provide flame feedback and flame sensing/detection. The sensor may be an optical sensor. This sensor data could be processed by the processor 74, and as a result the controller 72 could command the power distribution unit 52 to decrease the power provided to one of the heating elements 24 or grates 26 or all of the heating elements 24 or grates 26. This can further enable intelligent decisions when flames are coming into contact with the food to prevent the food from burning.

In another implementation, the electric grill 10 may be self-powered. For instance, the power system 50 can include solar panels 100 or other energy capturing technology. The solar panels 100 may be integrated into the lid or other parts of the electric grill that are exposed to the sun. Alternatively, the user may have to set solar panels 100 out near the grill to capture solar energy. The power generated by the solar panels 100 can be provided to the power distribution unit 52 and ultimately to the charger 58 to recharge the energy storage devices 56. Over the course of a week, it is possible for 2 ft×2 ft solar panel to charge a 6 kwh system. This could provide for two hours of high power cooking. The electric grill 10 could have a solar tracking system 102. The solar tracking system 102 may include a solar tracking sensor and could move the solar panels 100 and/or the electric grill 10 to follow the movement of the sun to optimize capturing solar energy. For instance, the solar tracking system 102 may include lifting and movement actuators operatively connected to the solar panel 100 to position the solar panel 100. The lifting and movement actuators may be controlled by the controller 72. The electric grill 10 could use its own battery power to lift and move the solar panels 100. To effectively track the movement of the sun, the electric grill 10 may have powered wheels that can automatically move to find the sun or even rotate to track the sun.

The heating elements 24 can be configured and/or positions to allow different temperature zones and cooking techniques within the compartment 20. For instance, the heating elements 24 may be bent and shaped such that a searing portion 110 of the coil that makes up the heating element 24 is positioned in close proximity to the grate 26 and cooking portion 112 of the coil is positioned further from the grate 26. Because of the proximity to the grate 26, the scaring portion 110 of the heating element 24 creates a high temperature zone in the compartment and on the grate may have high temperatures for searing the food placed on the cooking surface 28. The cooking portion 112 may have generate sufficient heat to cook the food placed on the cooking surface 28, but the temperature on the grate 26 above the cooking portion 112 may less than the temperature on the grate 26 above the searing portion 110. In another configuration, a heating element 24 can also be provided as a broiling emitter on the back side or top of the electric grill 10.

The heating elements 24 may be selectively positionable within the compartment 20. For instance, the heating elements 24 could be placed on a moveable carriage 120 that allows the heating element 24 to move up and down in within the compartment 20. A user could manually move the position of the heating elements 24 on the movable carriage 120 with a handle extending out of the compartment 20 to change the distance between the heating elements 24 and the grates 26. Accordingly, the heating elements can be placed in close proximity to the grates 26 and transfer more heat to the grates 26. Alternatively, the heating elements 24 may also be operatively coupled to an automatic movement system 122 configured to move the heating elements. In this configuration, the electric grill 10 may include actuators operatively couple to the heating elements 24 individually or a movable carriage. Based on input from the user or sensor data, the controller 72 can command the actuators to move the heating elements 24 upwards or downwards in the compartment 20 to change the position of the heating elements 24 relative to the grate 26. It will be appreciated that the closer the heating elements 24 are to the grate 26, more heat is transferred to the grate 26 to cook food placed on the cooking surface 28. As such, the movable carriage 120 or automatic movement system 122 could allow the user to selectively cook and grill items in a localized area.

The controller 72 can receive input data and sensor data and control the power system 50 to intelligently meter the power provided to the heating elements 24 in the compartment 20. The sensor system 60 can include sensors to detect if food is on a grate 26, the cooking surface 28, or in a specific area of the grates 26. For instance, the sensor system 60 may include sensors like scales, capacitive sensors, or conductive sensors to determine if food is on or in contact with the cooking surface 28. Further, a load cell may be coupled to the grates 26. The output of the sensors and load cell, for instance the detected weight of the food on the cooking surface 28, may be used to determine and control cooking and heating parameters like time, temperature, or any cooking programs. Further, the electric grill 10 may include interleaved powered and receiving grate members that could determine where food is place on the grate. The controller 72 could power different areas or zones to increase or decrease the temperature of those zones of the electric grill 10 based on the placement of the food on the cooking surface 28. The power provided to the heating elements 24 could be adjusted to cook the food based on the sensor data. Additionally, the weight of the food on the grill can be analyzed to determine the readiness or doneness of the food. Generally, food may lose weight because of water loss in the cooking cycle. The load cells or sensors can detect the loss of weight of the food on the cooking surface 28 and the processor can analyze the sensor data to determine the approximate doneness or readiness of the food. For example, a first hamburger may be placed in a first zone and a second hamburger may be placed on a second zone. Each zone is equally powered to cook each hamburger but can be independently controlled by the controller 72. Each zone can sense the weight of the hamburger as it cooks. As time passes, the first and second hamburgers may cook at different rates. If the first hamburger is cooking at a slower rate, the heating element 24 of the first zone may be adjusted to increase the temperature to decrease the cooking time. If the hamburger in the second zone is cooking too fast, the heating element 24 of the second zone can be independently controlled from the first zone, and selectably adjusted to increase the cooking time.

The electric grill 10 may be heavier than traditional grills because the added weight of electrical components included on the grill, particularly the energy storage devices 56. To assist with moving the electric grill 10, the wheels/casters of the electric grill 10 can be powered by electric motors to move the grill. The electric grill 10 can have motion controls included in the user interface 86. For instance, the user interface 86 of the controller 72 may include touchscreen movement controls. Alternatively, a forward or reverse motion can be controlled by a switch, variable switch, tilt switch, or push to power technology like on an e-bike. The electric grill may include electronic actuators to help assist a grill to move up stairs.

The electric grill 10 may include anti-flame or flame extinguishing features. For instance, the housing 12 can include vents. Actuators operatively connected to the vents that are configured to close the vents if flames are detected within the compartment 20. For instance, if a sensor of the sensor system 60 detects flames within the compartment 20, temperature in excess of a temperature threshold, or extreme temperatures within the compartment, the controller 72 may place the grill into a flame or fire management mode. In an embodiment, the sensor may be an optical sensor. In the fire management mode, the controller 72 may command the actuators to close the vents in the housing 12, shut off the power provided to the heating elements 24, and close the lid 22. The lid may provide a sufficient seal with the open end 14 to prevent the air from feeding a fire within the compartment. As such, detecting these events and subsequently closing the vents will assist in extinguishing an active flame. Alternatively, the electric grill does not have the same air requirements as standard gas grills that rely on combustion to generate heat. Therefore, the housing 12 may not have any vents that need to be closed if a flame is detected. The vents can be placed in an open position to increase airflow from the ambient environment into the compartment 20. The increased airflow may decrease the temperature within the compartment 20 and therefore allow the electric grill 10 to cool quicker than when the vents are in the closed position.

The electric grill 10 may have a powered lid 22. The electric grill 10 can include actuators or other motion controls that are operatively coupled to the lid 22 and that are controlled by the controller 72 to move the lid 22. For instance, an actuator or motor operatively coupled to the powered lid 22 could rotate or pivot the lid 22 up and down at the touch of a button on the user interface 86. Further, the metal handle of the grill lid 22 can have capacitive touch sensors in communication with the controller 72 and actuators to facilitate the motion of the lid. For instance, when the user touches the handle, the lid 22 will lift. To close the lid 22, the user can touch a switch or a designated portion of the handle. The duration of the contact on the handle that is detected by the capacitive touch sensors could also control the motion of the lid. For instance, the capacitive touch sensor could detect the user touching and holding the handle, and the controller 72 could command the actuators to move the lid 22 to an open position. To close the lid, the user could tap the handle, the capacitive touch sensor could detect this tap, and the controller 72 could command the actuator to move the lid 22 to a closed position.

The electric grill 10 may include a locking feature 130 configured to prevent access to the electric grill 10. The locking feature 130 could include a physical locking mechanism like a hook and latch mechanism that physically engages to prevent the lid 22 from being moved to an open position. Alternatively, the locking feature 130 could be an electric lock that prevents the electric grill from being powered on until the controller 72 verifies the user is an authorized user of the grill. For instance, the electric lock may include a biometrics scanner like a finger print reader, a code or other features to unlock the locking feature 130 to allow access to the electric grill 10. This locking feature 130 could allow the user to make the grill tamper proof for children. A variety of intelligent controls could be used. For instance, the grill could be powered on through voice activation and recognition, biometrics scans like finger print reading, key code, RFID keys, or other suitable means.

In another implementation, the electric grill 10 could also act as a backup power supply for a house. If there is a power outage, the electric grill 10 could also serve as a battery backup system of the residence as it could power the residence or appliances in the residence in an emergency situation. For instance, the energy stored in the energy storage devices 56 can be provided as an output of the power distribution unit 52 to output outlets on the grill. This power could be used to provide limited power to essential electrical appliances in the home during a power outage.

Embodiment 1: An electric barbecue grill, comprising a heating element configured to generate heat to cook food and a power distribution unit configured to receive power from an external power source and/or an energy storage device. The power distribution unit is configured to distribute power to the heating element.

Embodiment 2: The electric barbecue grill of embodiment 1, further comprising at least one more heating element.

Embodiment 3: The electric barbecue grill of embodiments 1 or 2, further comprising at least one more energy storage device.

Embodiment 4: The electric barbecue grill of any one of embodiments 1 to 3, further comprising a charging unit configured to receive power from the external power source and recharge the energy storage device when the electric grill is a recharge mode.

Embodiment 5: The electric barbecue grill of any one of embodiments 1 to 4, further comprising a grate having at least one channel in the grate configured to receive the heating element.

Embodiment 6: The electric barbecue grill of embodiment 5, further comprising a backing plate selectively secured to the grate to retain the heating element within the at least one channel.

Embodiment 7: The electric barbecue grill of any one of embodiments 1 to 4, further comprising a grate, wherein the heating element is selectively positionable below the grate between a position between a contact position and a distal position.

Embodiment 8: The electric barbecue grill of any one of embodiments 1 to 4, further comprising a grate, wherein the heating element is selectively positionable below the grate between a position between a contact position and a distal position.

Embodiment 9: The electric barbecue grill of embodiment 8, wherein the heating element is manually positionable.

Embodiment 10: The electric barbecue grill of embodiment 8, further comprising an actuator operatively coupled to the heating element, wherein the actuator is configured to position the heating element between a contact position and a distal position.

Embodiment 11: The electric barbecue grill of any one of embodiments 1 to 10, wherein the heating element is a made of a resistive material configured to generate heat from at least one of power supply or an energy storage device, and wherein the power supply has a voltage in the range of 110V-240V and a current in the range of 20 A-30 A and the energy storage device has a voltage in the range of 24V-240V and an energy capacity in the range of 20 Ah-200 Ah.

Embodiment 12: The electric barbecue grill of any one of embodiments 1 to 11, wherein the heating element is configured to generate heat from a power supply and a second heating element is configured to generate heat from an energy storage device, and the heating element and the second heating element generate heat to cook food in a run mode of the grill, wherein the power supply has a voltage in the range of 110V-240V and a current in the range of 20 A-30 A and the energy storage device has a voltage in the ranges in 24V-240V and an energy capacity in the range of 20 Ah-200 Ah.

Embodiment 13: The electric barbecue grill of any one of embodiments 1 to 4 and 7 to 10, wherein the heating element is an induction coil configured to generate heat with an inductive heating grate.

Embodiment 14: The electric barbecue grill of any one of embodiments 1 to 5 and 7 to 12, wherein the heating element is bent to form a heating zone in a first portion of the heating element and a searing zone in a second portion of the heating element, wherein the searing zone is configured to be closer a grate than the heating zone.

Embodiment 15: The electric barbecue grill of any one of embodiments 1 to 14, further comprising at least one motor operatively coupled to wheels or casters secured to the grill, wherein the at least one motor receives power from the energy storage device and is configured to assist moving the grill.

Embodiment 16: An electric barbecue grill, comprising a heating element configured to generate heat to cook food, a solar panel configured to receive light from the sun and convert it to power; and a power distribution unit configured to receive power from an external power source, the solar panel and/or an energy storage device. The power distribution unit is configured to distribute power to the heating element.

Embodiment 17: The electric barbecue grill of embodiment 16, further comprising a charging unit configured to receive power from the external power source and the solar panel to recharge the energy storage device when the electric grill is a recharge mode.

Embodiment 18: The electric barbecue grill of embodiments 16 or 17, further comprising a tracking system configured to present the solar panel to direct sunlight by rotating the solar panel or the electric grill.

Embodiment 19: An electric barbecue grill, comprising at least one heating element configured to generate heat to cook food, at least one grate configured to receive heat from the heating element, the grate having a cooking surface, and a power distribution unit configured to receive power from an external power source and/or an energy storage device. The power distribution unit is configured to distribute power to the at least one heating element. The grill has a controller that receives input data from a user interface and outputs control signals to control the power distribution unit. Wherein the controller includes at least one processor and a memory that stores instructions. When executed by the at least one processor, the instructions configure the at least one processor to distribute power to the heating element to adjust from the external power source or the energy storage device based on the input data to adjust a cooking temperature of the electric grill.

Embodiment 20: The electric barbecue grill of embodiment 19, further comprising a sensor operatively coupled to the at least one grate to detect if food has been placed on the at least one grate and a level of doneness of food on the at least one grate. The input data further includes sensor data from the sensor and the processor is further configured to increase or decrease the power provided to the at least one heating element to adjust the cooking temperature based on the detected level of doneness of the food.

Embodiment 21: The electric barbecue grill of embodiment 20, wherein the sensor detects an initial weight of food on the grate and a subsequent weight of the food and the processor is configured to determine the level of doneness based on the difference between the initial weight and the subsequent weight.

Embodiment 22: The electric barbecue grill of any one of embodiments 19 to 21, further comprising a lid having an open position and a closed position and a sensor operatively coupled to the lid to detect the position of the lid. The input data further includes sensor data from the sensor and the processor is further configured to increase power to the at least one heating element to increase the cooking temperature when the lid is in the open position, decrease power to the at least one heating element to decrease the cooking temperature when the lid is in the open position, increase the power provided to the at least one heating element to increase the cooking temperature when the lid is in the closed position, and/or decrease the power provided to the at least one heating element to decrease the cooking temperature when the lid is in the closed position.

Embodiment 23: The electric barbecue grill of embodiment of any one of embodiments 19 to 22, further comprising a housing having at least one vent, an actuator operatively coupled to the vent and configured to move the vent between an open position and a closed position, and a sensor in communication with an interior of the housing configured to detect flames or temperatures above a threshold. The input data further includes sensor data from the sensor and the processor is further configured to decrease the power provided to the at least one heating element to decrease the cooking temperature and command the actuator to move the vent to the closed position when the sensor detects a flame and/or a temperature above a threshold or command the actuator to move the vent to an open position to decrease the temperature in the housing.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. An electric barbecue grill, comprising:
a heating element configured to generate heat to cook food; and
a power distribution unit configured to receive power from an external power source and/or an energy storage device, the power distribution unit configured to distribute power to the heating element.

2. The electric barbecue grill of claim 1, further comprising at least one more heating element.

3. The electric barbecue grill of claim 1, further comprising at least one more energy storage device.

4. The electric barbecue grill of claim 1, further comprising a charging unit configured to receive power from the external power source and recharge the energy storage device when the electric grill is a recharge mode.

5. The electric barbecue grill of claim 1, further comprising a grate having at least one channel in the grate configured to receive the heating element.

6. The electric barbecue grill of claim 5, further comprising a backing plate selectively secured to the grate to retain the heating element within the at least one channel.

7. The electric barbecue grill of claim 1, wherein the heating element is integrally formed with a grate such that the grate is a coating or metal tube encasing the heating element.

8. The electric barbecue grill of claim 1, further comprising a grate, wherein the heating element is selectively positionable below the grate between a position between a contact position and a distal position.

9. The electric barbecue grill of claim 8, wherein the heating element is manually positionable.

10. The electric barbecue grill of claim 8, further comprising an actuator operatively coupled to the heating element, wherein the actuator is configured to position the heating element between a contact position and a distal position.

11. The electric barbecue grill of claim 1, wherein the heating element is a made of a resistive material configured to generate heat from at least one of power supply or an energy storage device, wherein the power supply has a voltage in the range of 110V-240V and a current in the range of 20 A-30 A and the energy storage device has a voltage in the range of 24V-240V and an energy capacity in the range of 20 Ah-200 Ah.

12. The electric barbecue grill of claim 9, wherein the heating element is configured to generate heat from a power supply and a second heating element is configured to generate heat from an energy storage device, and the heating element and the second heating element generate heat to cook food in a run mode of the grill, wherein the power supply has a voltage in the range of 110V-240V and a current in the range of 20 A-30 A and the energy storage device has a voltage in the ranges in 24V-240V and an energy capacity in the range of 20 Ah-200 Ah.

13. The electric barbecue grill of claim 1, wherein the heating element is an induction coil configured to generate heat with an inductive heating grate.

14. The electric barbecue grill of claim 1, wherein the heating element is bent to form a heating zone in a first portion of the heating element and a searing zone in a second portion of the heating element, wherein the searing zone is configured to be closer a grate than the heating zone.

15. The electric barbecue grill of claim 1, further comprising at least one motor operatively coupled to wheels or casters secured to the grill, wherein the at least one motor receives power from the energy storage device and is configured to assist moving the grill.

16. An electric barbecue grill, comprising:
a heating element configured to generate heat to cook food;
a solar panel configured to receive light from the sun and convert it to power; and
a power distribution unit configured to receive power from an external power source, the solar panel and/or an energy storage device, the power distribution unit configured to distribute power to the heating element.

17. The electric barbecue grill of claim 16, further comprising a charging unit configured to receive power from the external power source and the solar panel to recharge the energy storage device when the electric grill is a recharge mode.

18. The electric barbecue grill of claim 16, further comprising a tracking system configured to present the solar panel to direct sunlight by rotating the solar panel or the electric grill.

19. An electric barbecue grill, comprising:
at least one heating element configured to generate heat to cook food;
at least one grate configured to receive heat from the heating element, the grate having a cooking surface;
a power distribution unit configured to receive power from an external power source and/or an energy storage device, the power distribution unit configured to distribute power to the at least one heating element; and
a controller that receives input data from a user interface and outputs control signals to control the power distribution unit, wherein the controller includes:
at least one processor; and
a memory that stores instructions that, when executed by the at least one processor, configure the at least one processor to:
distribute power to the heating element from the external power source or the energy storage device based on the input data to adjust a cooking temperature of the electric grill.

20. The electric barbecue grill of claim 19, further comprising a sensor operatively coupled to the at least one grate to detect if food has been placed on the at least one grate and a level of doneness of food on the at least one grate,
wherein the input data further includes sensor data from the sensor and the processor is further configured to increase or decrease the power provided to the at least one heating element to adjust the cooking temperature based on the detected level of doneness of the food.

21. The electric barbecue grill of claim 20, wherein the sensor detects an initial weight of food on the grate and a subsequent weight of the food and the processor is configured to determine the level of doneness based on the difference between the initial weight and the subsequent weight.

22. The electric barbecue grill of claim 19, further comprising a lid having an open position and a closed position and a sensor operatively coupled to the lid to detect the position of the lid,
wherein the input data further includes sensor data from the sensor and the processor is further configured to increase power to the at least one heating element to increase the cooking temperature when the lid is in the open position, decrease power to the at least one heating element to decrease the cooking temperature when the lid is in the open position, increase the power provided to the at least one heating element to increase the cooking temperature when the lid is in the closed position, and/or decrease the power provided to the at least one heating element to decrease the cooking temperature when the lid is in the closed position.

23. The electric barbecue grill of claim 19, further comprising a housing having at least one vent, an actuator operatively coupled to the vent and configured to move the vent between an open position and a closed position, and a sensor in communication with an interior of the housing configured to detect flames or temperatures above a threshold,
wherein the input data further includes sensor data from the sensor and the processor is further configured to decrease the power provided to the at least one heating element to decrease the cooking temperature and command the actuator to move the vent to the closed position when the sensor detects a flame and/or a temperature above a threshold or command the actuator to move the vent to an open position to decrease the temperature in the housing.
